(19) United States
(12) Patent Application Publication
(10) Pub. No.: US 2022/0041239 A1
(43) Pub. Date: Feb. 10, 2022

(54) APPARATUS FOR COVERING A VEHICLE EMPLACEMENT AND IMPLEMENTATION METHOD

(71) Applicant: Smart Mobility Solutions S.r.l., BOLZANO (IT)

(72) Inventors: Diego Divenuto, BOLZANO (IT); Marco Ferrarin, LAIVES (Bolzano) (IT)

(21) Appl. No.: 17/275,844

(22) PCT Filed: Sep. 12, 2019
(86) PCT No.: PCT/IB2019/057696

§ 371 Date: Mar. 12, 2021

(30) Foreign Application Priority Data
Sep. 13, 2018 (IT) 102018000008565

(51) Int. Cl. B62J 17/04; B62J 17/083; B62J 9/21

(52) U.S. Cl. CPC B62J 17/04; B62J 6/03; B62J 9/21; B62J 17/083

(57) ABSTRACT

An apparatus (10) for covering a vehicle emplacement, in particular a bicycle, comprises: a pair of extendible uprights (20), each of which is connectable to a portion of a vehicle and is movable between a rest configuration and an operating configuration; at least one abutment element (30) solidly associated with a portion of an upright (20); a covering (40) that is configurable between a compact condition and a stretched condition. Furthermore, the covering (40) is slidably movable along a movement direction (M) that extends between an end (21) and the abutment element (30) of each upright (20) to come into contact with each abutment element (30) for pulling it in the movement direction (M) and extending each upright (20) to cover the vehicle emplacement.

The subject matter of the present patent application is also a method for the implementation of the aforesaid apparatus.

### TECHNICAL FIELD

The present invention relates to an apparatus for covering a vehicle. In particular, the invention relates to an apparatus for covering a vehicle emplacement so as to protect the user located at the emplacement from rain or solar radiation.

The invention is also intended for a bicycle on which such apparatus is installed for covering an emplacement thereof.

Furthermore, the invention is related to a method for the implementation of such apparatus on a vehicle.

### PRIOR ART

It is currently known to use devices for covering vehicles of the type described in document DE202014102484. Such devices are able to offer protection for the user of the vehicle during adverse weather conditions, such as rain, wind or solar radiation.

Usually, these covering devices are installed on the bicycles, as they have a contained weight and different coupling points able to be connected to the vehicle frame, in the specific case to the bicycle frame.

However, despite their manageability, these devices have significant installation and implementation times, during which the user remains exposed to the adverse weather conditions.

Additionally, such devices are generally installed on the vehicle only during the use thereof. On the other hand, before and after their use they are inconveniently stored in relevant cases that the user must transport (possibly in addition to other bags) and at the same time keep handy in case they need to be quickly installed.

Additionally, for example following a storm, the wet cover is put back into the case before it is completely dry, not having dried completely and wetting the case itself, forming water stagnation.

### SUMMARY

In this context, the technical task underpinning the present invention is to propose an apparatus for covering a vehicle emplacement, in particular for covering a bicycle, which obviates the drawbacks of the prior art cited above.

In particular, an object of the present invention is that of providing an apparatus for covering an emplacement of a vehicle that can be installed and implemented with extreme ease, so as to be able to guarantee for the user of the vehicle immediate cover against adverse weather conditions. Another object of the present invention is that of providing an apparatus for covering a vehicle that can be easily put away when not in use, but at the same time easy to access for subsequent use.

A further object of the present invention is that of providing a method for implementing an apparatus for covering a vehicle that can offer a simple and quick process for implementing an apparatus for covering a vehicle. The stated technical task and specified objects are substantially reached by an apparatus for covering a vehicle emplacement and a method for implementing such apparatus, which comprise the technical features disclosed in the independent claims. The dependent claims correspond to further advantageous aspects of the invention.

It should be highlighted that this summary introduces, in simplified form, a selection of concepts which will be further elaborated in the detailed description given below.

The invention relates to an apparatus for covering a vehicle emplacement, in particular a bicycle. Specifically, the apparatus comprises a pair of extendible uprights and having an end connectable to a portion of the vehicle; at least one abutment element solidly associated with a portion of a respective upright; and a covering that is configurable between a compact condition, in which it is entirely wrapped between the pair of uprights for occupying the minimal amount of space, and a stretched condition, in which it is stretched along the pair of uprights for covering at least a part of the vehicle emplacement.

More precisely, the covering is slidably movable along a movement direction that extends between the end and the abutment element of each upright and is configured to enter into contact with each abutment element for pulling it in the movement direction and extending each upright from a rest configuration, in which each of them extends by a minimum length, to an operating configuration, in which each of them has a predetermined length such as to cover at least part of the vehicle emplacement.

In other words, the movement of the covering from the compact condition to the extended condition allows the simultaneous movement of the pair of uprights from the rest configuration to the operating configuration.

More precisely, the apparatus allows the uprights to be extended from a minimum length to a predefined length simultaneously to the extension of the covering, which in the stretched condition is wrapped around the uprights to form a cover for the emplacement of a vehicle on which the apparatus is installed.

Preferably, each upright can be folded between the rest configuration and the operating configuration. In this way, the uprights in the rest configuration are substantially stacked against each other, whereas in the operating configuration the uprights are substantially extended parallel to each other to cover at least part of a vehicle emplacement.

Even more preferably, the apparatus comprises an articulation element interposed between the end of each upright and a portion of a vehicle. The articulation element is configured to move the pair of uprights between the rest configuration and the operating configuration.

The uprights in the rest configuration have a minimum length and are arranged on the same plane substantially parallel to the ground. Instead, in the operating configuration, the uprights extend parallel to one another by a predefined length so as to form a cover for the vehicle emplacement on which the apparatus is installed. Therefore, advantageously, the articulation element interposed between each upright and the vehicle allows the pair of uprights to be rotated between the rest configuration and the operating configuration.

According to an aspect of the invention, each upright is telescopic. Specifically, each upright comprises a plurality of rods slidably inserted inside each other for extending the respective upright between a minimum length and the predetermined length of the operating configuration. Advantageously, a telescopic upright allows the dimensions to be reduced during the rest configuration.

Preferably, each upright comprises at least one locking device interposed between two of its own rods to lock the mutual position thereof and define the predefined length of each upright when in the operating configuration. Advantageously, each locking device prevents each upright from getting shorter after being extended into the operating configuration. In practice, each locking device keeps the predefined length of each upright constant, i.e. it keeps the relative position in which the rods are arranged after the extension of the uprights constant.

According to an aspect of the invention, the pair of uprights in the operating configuration extends along a curved movement direction so as to form, with the covering in the stretched condition, a front protective shield with respect to an advancement direction of a vehicle and an upper protective shield with respect to a vehicle emplacement.

Advantageously, each upright, and specifically each rod that composes an upright, has a radius of curvature for which the extension of the upright during the movement from the rest configuration to the operating configuration allows the apparatus to define a front protection with respect to the travel direction, e.g. against rain and/or wind, and an upper protection with respect to a vehicle emplacement, e.g. against rain or solar radiation.

According to another aspect of the invention, each upright has a substantially elliptical shaped section.

Alternatively, each upright can be formed with a different section from the elliptical one, such as for example a square or rectangular section. Advantageously, in this way, each rod of an upright maintains the correct orientation with respect to the others and with respect to the movement direction, e.g. preventing involuntary rotations.

According to a further aspect of the invention, the apparatus comprises an anchoring device interposed between each upright and a portion of the vehicle. For example, the anchoring device can be fixed directly or indirectly—e.g. through the interposition of a luggage carrier—to the vehicle. In detail, the anchoring device has a variable width for varying the distance that exists between the pair of uprights.

Advantageously, an anchoring device having a variable width allows the relative distance between the uprights in the operating configuration to be increased or decreased, so as to widen or restrict the cover provided by the apparatus and, therefore, placing the covering in tension during use. According to an aspect of the invention, the apparatus comprises at least one cross member slidably movable along the movement direction between the anchoring device and each abutment element of the pair of uprights. The cross member is conformed to be engaged with each abutment element so as to move the pair of uprights between the rest configuration and the operating configuration. The cross member is also operatively connected to the covering.

The cross member interposed between the pair of uprights is able to provide greater solidity for the structure with respect to external stress when the pair of uprights is in the operating configuration. Additionally, the cross member, being advantageously connected also to the covering, offers a more ergonomic portion for pulling the uprights from the rest configuration to the operating one simultaneously to the movement of the covering from the compact condition to the extended one.

Preferably, the cross member is telescopic for having a variable width as a function of the width of the anchoring device.

In this way, the cross member is advantageously able to adapt to the distancing or nearing of the uprights induced by the adjustment of the width of the anchoring device.

Even more preferably, the apparatus comprises a plurality of cross members slidably movable along the movement direction between the anchoring device and each abutment element of the pair of uprights. According to an aspect of the invention, the apparatus comprises a container removably connected to a portion of a vehicle for containing the pair of uprights in the rest configuration and the covering in the compact condition.

Preferably, the container comprises a base that can be anchored to a vehicle. The base also has a drainage hole.

Advantageously, in the event that the covering is put back inside the container, e.g. following a storm, the water will be drained outside the container preventing any stagnation inside.

According to another aspect of the invention, the container has at least one housing into which a luminous or reflecting device can be inserted. In this way is it advantageously possible to install headlamps and/or retro-reflectors to improve visibility and safety during night-time use of the vehicle on which the apparatus is installed.

According to a further aspect of the invention, the apparatus comprises an external appendage for defining an object holder area.

Advantageously, the apparatus comprises an appendage external to the container, useful for placing any objects in the event in which the covering and pair of uprights are contained inside the container when the use thereof is not necessary.

According to an aspect of the invention, the covering comprises a pair of slotted portions configured to slide along the pair of uprights between each end and each abutment element.

According to a further aspect, the front protective shield of the coating has a through opening.

The through opening, advantageously, allows a potential operator placed at the emplacement covered by the apparatus to have greater visibility of the travel direction during use of the vehicle.

Preferably, the front protective shield comprises a cover removably connected at the through opening.

Therefore, if necessary, it is advantageously possible to close the through opening of the front protective shield.

According to another aspect of the invention, at least a part of the front protective shield is transparent.

Advantageously, at least the cover of the front protective shield is transparent so that the user can have a good view while the vehicle is moving and, at the same time, is protected by the apparatus.

According to a further aspect, the covering comprises at least one tensioning element for tensioning the covering onto the pair of uprights when in the operating configuration.

To confer greater solidity to the apparatus, when the cloth is stretched onto the pair of uprights, at least one tensioning element can be activated for tensioning and making the covering more adherent to the pair of uprights.

A bicycle comprises the apparatus for covering an emplacement thereof as described above.

Preferably, the apparatus is installed at a front portion of the bicycle.

A method for implementing an apparatus for covering an emplacement of a vehicle, in particular a bicycle, comprising the operating steps of:
providing a pair of extendible uprights, each of which has an end connected to a portion of a vehicle. In detail, the uprights are movable between a rest configuration, in which they extend by a minimum length, and an operating configuration, in which they have a predetermined length such as to cover at least part of said vehicle emplacement;
providing at least one abutment element solidly associated with a portion of a respective upright;
slidably arranging a covering along the pair of uprights between each end and the respective abutment element. The covering is also configurable between a compact condition, in which it is entirely wrapped between the pair of uprights in a rest configuration, and a stretched condition, in which it is stretched along the pair of uprights in an operating configuration so as to cover at least part of said emplacement of a vehicle;
slidably removing the covering in a movement direction that extends between the end and the abutment element of each upright from the compact condition to the stretched condition. The covering is configured to come into contact with each abutment element for pulling it in the movement direction and extending each upright outside the container. Preferably the method comprises the steps of:
arranging a cross member, operatively connected to the coating, slidably movable along the movement direction between each end and each abutment element of the pair of uprights;
moving the cross member along the movement direction for engaging it with each abutment element so as to move the pair of uprights between the rest configuration and the operating configuration. Additionally, the method comprises the steps of:
interposing an anchoring device between each upright and a portion of a vehicle;
varying the width of the anchoring device for varying the distance that exists between the pair of uprights in the operating configuration. According to an aspect of the invention, the method comprises the step of providing a container removably connectable to a portion of a vehicle for containing the pair of uprights in the rest configuration and the covering in the compact condition.

### BRIEF DESCRIPTION OF THE DRAWINGS

Further characteristics and advantages of the present invention will more fully emerge from the non-limiting description of a preferred but not exclusive embodiment of an apparatus for realising an apparatus for covering an emplacement of a vehicle, as illustrated in the accompanying drawings, in which:

FIG. 1 illustrates an axonometric view of an apparatus for covering a vehicle emplacement in a rest configuration;

FIG. 2 illustrates an axonometric view of the apparatus for covering the vehicle emplacement illustrated in FIG. 1 in an operating configuration;

FIG. 3 illustrates an axonometric view of a bicycle on which the apparatus illustrated in FIGS. 1 and 2 is installed, contained inside a relevant container;

FIG. 4 illustrates an axonometric view of the bicycle and apparatus illustrated in FIGS. 1 and 2 during a movement step thereof from the configuration of FIG. 1 to the configuration of FIG. 2;

FIG. 5 illustrates an axonometric view of the bicycle and apparatus for covering a vehicle emplacement in use;

FIG. 6 illustrates an axonometric view of two different arrangements of uprights in the operating configuration dependent on the width at which the anchoring device is arranged, respectively larger to the left and smaller to the right;

FIG. 7 illustrates a perspective view according to a different point of view of the apparatus illustrated in FIG. 2 comprising the quick coupling device;

FIG. 8 illustrates a perspective view of a possible embodiment of the container containing the apparatus illustrated in FIG. 2 and connected to the vehicle through the quick coupling device;

FIG. 9 illustrates a rear view of the container illustrated in FIG. 8 and coupled to the vehicle.

With reference to the drawings, they serve solely to illustrate embodiments of the invention with the aim of better clarifying, in combination with the description, the inventive principles at the basis of the invention.

### DETAILED DESCRIPTION

The present invention is intended for an apparatus for covering a vehicle emplacement.

With reference to the figures, an apparatus for covering a vehicle emplacement has been generically indicated with the number 10.

Any modifications or variants which, in the light of the description, are evident to the person skilled in the art, must be considered to fall within the scope of protection established by the present invention, according to considerations of technical equivalence.

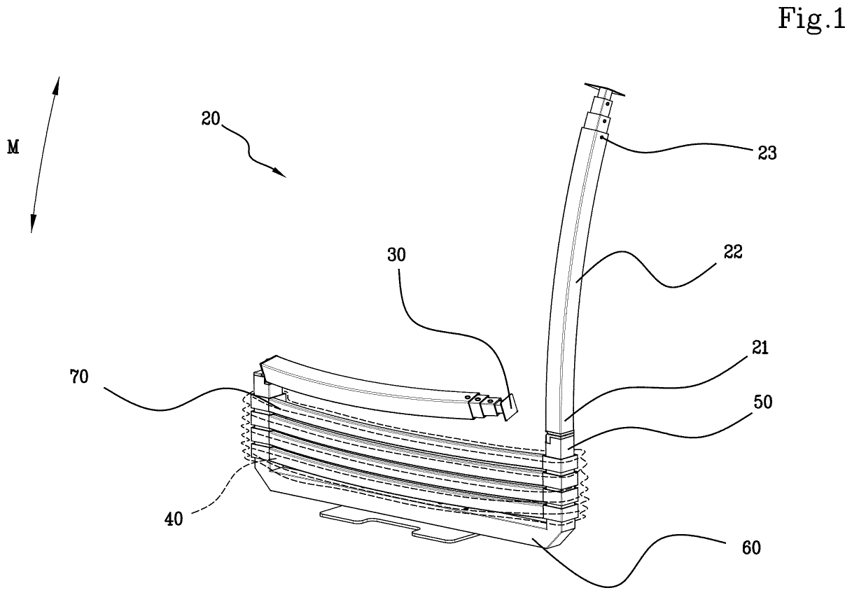

FIG. 1 illustrates an apparatus for covering a vehicle emplacement, in particular a bicycle.

However, the present invention can also be installed and used on other vehicles, such as prams or wheelchairs.

Specifically, the apparatus 10 comprises: a pair of extendible uprights 20, each of which has an end 21 connectable to a portion of a vehicle; at least one abutment element 30 solidly associated with a portion of each upright 20; and a covering 40 that is configurable between a compact condition, in which it is entirely wrapped between the pair of uprights 20 in the rest configuration, and a stretched condition, in which it is stretched along the pair of uprights 20 in the operating configuration so as to cover at least part of the vehicle emplacement.

In particular, the covering 40 is slidably movable along a movement direction M that extends between the end 21 and the abutment element 30 of each upright 20. In fact, the covering 40 has slotted portions 43 or sliding rings arranged along at least part of the perimeter for allowing the sliding along the uprights 20, when the latter are moved between the rest configuration and the operating configuration. Furthermore, the covering 40 is configured to come into contact with each abutment element 30 for pulling it in the movement direction M and, therefore, extending each upright 20 from the rest configuration to the operating configuration. Advantageously, each abutment element 30 is configured to define a stable connection with the covering 40 for simplifying the removal of the pair of uprights 20 at the same time as the stretching of the covering 40 to prevent the covering 40 itself from sliding out from the pair of uprights 20. According to a possible embodiment of the invention, each abutment element 30 is a jointing element such as to form a shape coupling with a portion of the covering 40 for keeping it firmly in position.

Advantageously, each abutment element 30 comprises a spring mechanism or the like such as, for example, a quick release button, that can be activated by the operator quickly to allow quick release of the covering 40 to be put back into the compact condition for the possible disassembly of the apparatus 10 (i.e. to put the pair of uprights 20 back into the rest configuration).

In the rest configuration each upright 20 is extended by a minimum length, whereas in the operating configuration each upright 20 extends by a predetermined length such as to cover at least part of the vehicle emplacement.

According to an aspect of the invention, each upright 20 is foldable around the end 21 thereof connected to the vehicle. Specifically, between each end 21 and the vehicle an articulation element 50 is interposed which allows the movement through rotation of the pair of uprights 20 between the rest configuration and the operating configuration.

The articulation element 50 is, for example, a hinge provided with a specific stop for locking in an open configuration so that the respective upright 20 connected thereto is locked in the operating configuration. In other words, the hinge is able to prevent any involuntary movement of the upright 20 connected thereto from the operating configuration to the rest configuration.

Preferably, the hinges used are a bayonet fixing system or of the non-parallel axis type, so that the uprights 20 in the rest configuration occupy a minimal amount of space and do not create an obstruction to each other during their movement between the rest configuration and the operating configuration but can instead be moved simultaneously.

In fact, the uprights 20 in the rest configuration are substantially stacked against each other, so as to be arranged substantially on a same plane parallel to the ground. Instead, in the operating configuration, the uprights 20 are arranged parallel to one another and extended by their predefined length so as to cover at least part of the vehicle emplacement on which the apparatus 10 is installed. In other words, according to an aspect of the invention, a bayonet fixing system or of the non-parallel axis type allows the pair of uprights 20 to be moved simultaneously from their stacked position (rest configuration) to their extensible position (i.e. when they are arranged parallel but not in the operating configuration). In this way, for example, in the event of using a bayonet fixing system, a subsequent minimum torsion around a respective articulation axis allows the respective upright 20 to be locked in a stable and self-supporting position for the covering 40 in the stretched condition. Therefore, more precisely, without the use of further fixing or locking systems (e.g. without the use of tie rods to be connected to a portion of the vehicle frame) the uprights 20 are able to independently support the entire structure of the apparatus 10 during the use thereof.

As can be seen in FIGS. 1, 2, 4, 5 each upright 20 is telescopic. More precisely, each upright 20 comprises a plurality of rods 22 slidably inserted inside each other for extending the respective upright 20 between the minimum length, when it is in the rest configuration, and the predetermined length, when it is in the operating configuration, for providing a cover for at least a part of the vehicle emplacement. Additionally, each upright 20 comprises at least one locking device 23 interposed between two of its own telescopic rods 22. In this way, the locking device 23 maintains constant the predetermined length in which each upright 20 is extended. In practice, the locking device 23 prevents the mutual sliding of the rods 22 between which it is arranged, preventing the length of each upright 20, in the operating configuration, from changing during the use of the apparatus 10.

The locking device 23, for example, is comprised of a metal slider arranged on a first rod and able to project towards a second rod, which is slidable on the first one as mentioned above. In this way, the metal slider interacts with a relevant hole present on the second rod for forming a mechanical retaining coupling able to prevent sliding between the rods, maintaining the related upright 20 extended by the predefined length. Advantageously, according to an embodiment of the invention, each abutment element 30 is connected to the respective locking devices 23 provided on the respective upright 20. In this way, when the covering 40 is to be put back in the compact condition and the pair of uprights 20 in the rest configuration, a single release mechanism, such as for example a quick spring release button, is able to operate simply and quickly the separation of the covering 40 from the abutment elements 30 and the disengagement of the locking devices 23 for compacting between them the rods 20 that form the respective uprights 20 configuring the latter in the extendible position before bringing them into the rest configuration. Preferably, each upright 20 has a substantially elliptical section for preventing the rods 22 from rotating involuntarily with respect to each other during the rest configuration of the upright 20, then preventing in the operating configuration the correct operation of the locking device 23. Alternatively, each upright 20 can be formed with a different section from the elliptical one such as, for example, a square, rectangular or any other shaped section that prevents the involuntary rotation between the rods 22 during their removal for example.

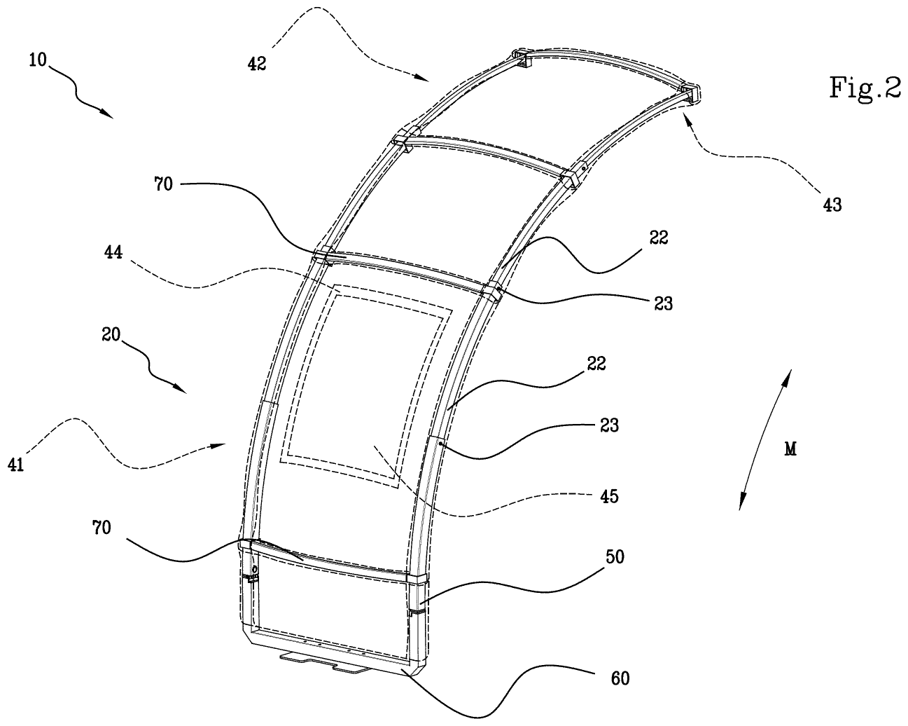

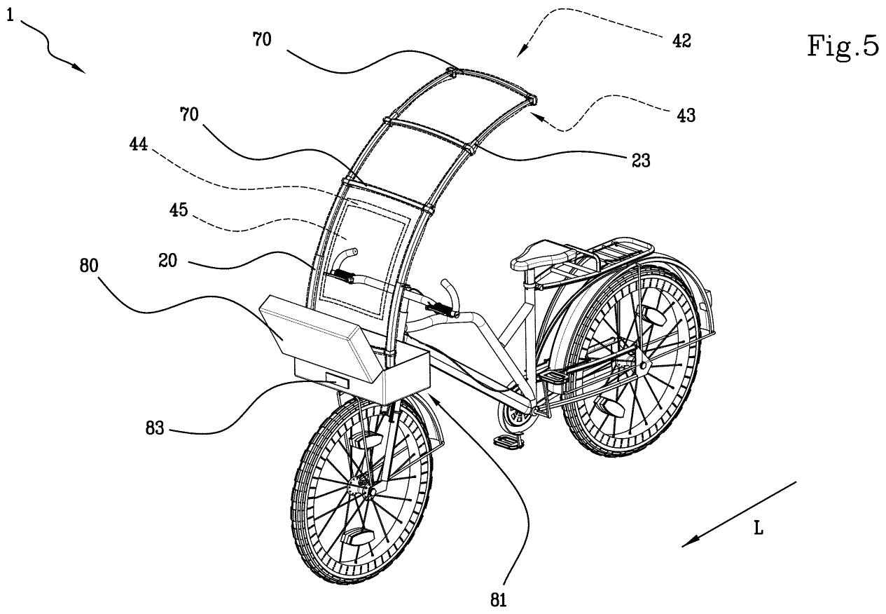

FIGS. 2 and 5 represent the apparatus 10 in which the pair of uprights 20 is in the operating configuration and the covering 40 is in the stretched condition. As can be noted from such figures, each upright 20 extends along the movement direction M, which is curved as each rod 22 of an upright 20 has a specific radius of curvature. In this way, the covering 40 stretched onto the pair of uprights 20 in the operating configuration forms a front protective shield 41 with respect to an advancement direction L of the vehicle, and an upper protective shield 42 with respect to the vehicle emplacement.

In other words, the uprights 20 in the operating configuration are self-supporting. More precisely, without the use of further fixing or locking systems (e.g. without the use of tie rods to be connected to a portion of the vehicle frame) the uprights 20 are able to independently support the entire structure of the apparatus 10 during use thereof.

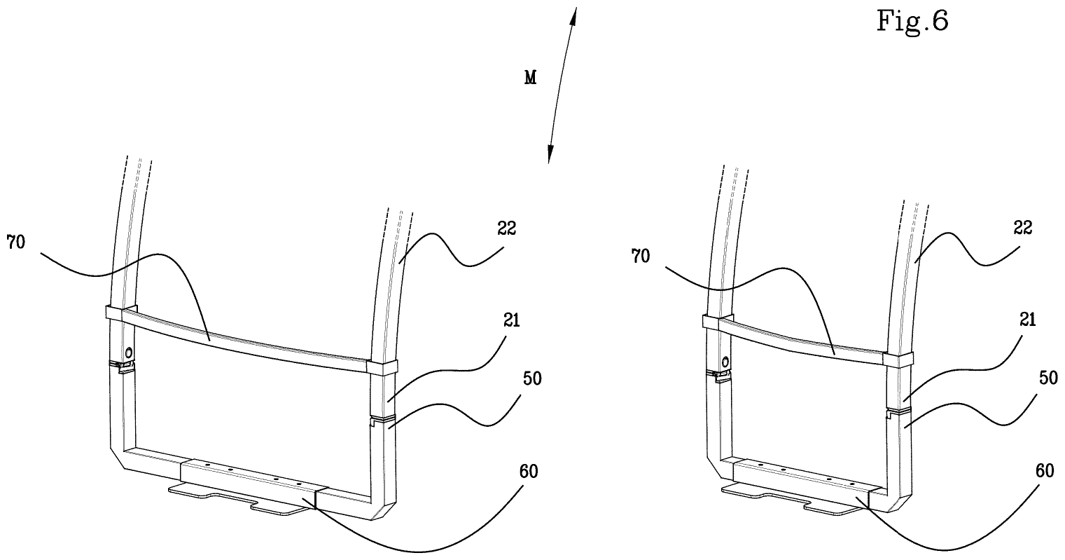

According to an aspect of the invention illustrated in FIGS. 1 and 2, an anchoring device 60 can be interposed between each articulation element 50 and the portion of the vehicle. Specifically, the anchoring device 60 is substantially U-shaped to allow the connection of an articulation element 50, and therefore of a respective upright 20, on each of the ends thereof, while the central portion comprised between such ends can be anchored to the vehicle. Furthermore, as better illustrated in FIG. 6, such anchoring device 60 has a variable width for moving the uprights 20 towards or away from each other, so as to vary the width of the front protective shield 41 and of the upper protective shield 42. In other words, the anchoring device 50 allows the total dimensions of the protective screen offered by the apparatus 10 to be managed according to requirements.

Advantageously, the adjustment of the width of the anchoring device 60 allows the covering 40 to be brought into tension after it has been moved from the compact condition to the extended condition.

In other words, the operation of the apparatus 10 envisages removing the uprights 20 from the rest condition to the operating condition and, at the same time, moving the covering 40 from the compact condition to the stretched condition. At this point, the covering 40 is stretched along the uprights 20 but in a slack condition which is not very practical for the user, as it can reduce the balance of the vehicle during use thereof. Therefore, the anchoring device 60 can be advantageously adjusted in width for distancing the pair of uprights 20 from each other and bringing the covering 40 stretched over them into tension.

According to a possible embodiment of the invention, the width of the anchoring device 60 is variable between a minimum width of 40 cm and a maximum width of 60 cm.

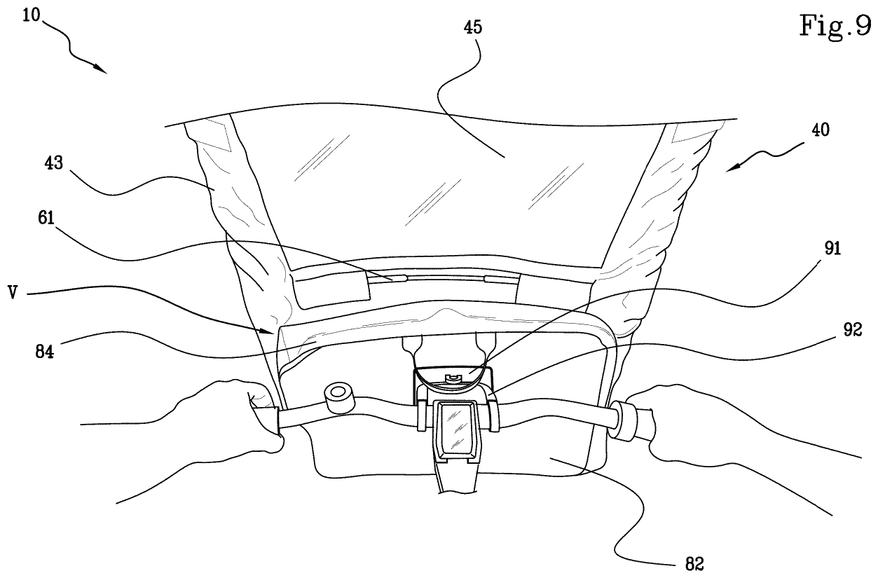

According to an aspect of the invention illustrated in FIG. 9, the apparatus 10 comprises at least one additional tensioning element 61 interposed between the pair of uprights 20 and connected to the covering 40. Preferably, the tensioning element 61 is arranged in proximity to one of the two pairs of ends 21 of the uprights 20 so as not to impede the view of the user of the vehicle and to increase, if necessary, the tensioning of the covering 40.

Additionally, as can be seen in FIGS. 1, 2, 4, 5, the apparatus 10 comprises a cross member 70 slidably movable along the movement direction M between each end 21 and each abutment element 30 of the pair of uprights 20. In other words, the cross member 70 is positioned along each upright 20 between the respective ends 21 and the respective abutment elements 30, so that it can slide between them. More precisely, the cross member 70 has slotted end portions, each of which is adapted to be arranged slidably along a respective upright 20.

The cross member 70 is further advantageously conformed to be engaged with each abutment element 30 of the pair of uprights 20 so as to move them between the rest configuration and the operating configuration. More precisely, the slotted end portions of the cross member 70 are conformed to determine a shape coupling with the abutment elements 30 and therefore to remove each rod 22 of the uprights 20 so that the locking device 23 allows sliding.

Even more advantageously, the abutment elements 30 are configured (e.g. thanks to a spring mechanism) to allow an operator to simply and quickly activate the separation thereof from the cross member 70 and, therefore, from the covering 40, to move the uprights 20 from the operating configuration to the rest configuration.

Furthermore, the cross member 70 provides an advantageous pulling portion that can be grasped by the user who, by moving it, is able to move the pair of uprights 20 from the rest configuration, extending them into the operating configuration.

Additionally, the cross member 70 is operatively connected to the covering 40 so that, during the movement of the pair of uprights 20, the cross member 70 is able to bring the covering 40 from the compact condition to the stretched condition to form the front protective shield 41 and the upper protective shield 42.

Preferably, the apparatus 10 comprises a plurality of cross members 70, each of which is slidably arranged along the pair of uprights 20, between each end 21 and each abutment element 30, and operatively connected to the covering 40.

In this way, when the pair of uprights 20 is in the operating configuration, the interposition of three or four cross members 70 confers greater resistance and solidity to the apparatus 10 during the use thereof. Additionally, each cross member 70 is telescopic, as its width is a function of the width to which the anchoring device 60 is set, able to be varied to bring into tension and/or change the dimensions of the front protective shield 41 and of the upper protective shield 42.

According to an aspect of the invention illustrated in FIG. 9, the anchoring device 60 is connected to a front portion of the vehicle (e.g. a luggage carrier or a handlebar) through the interposition of a quick coupling device 90.

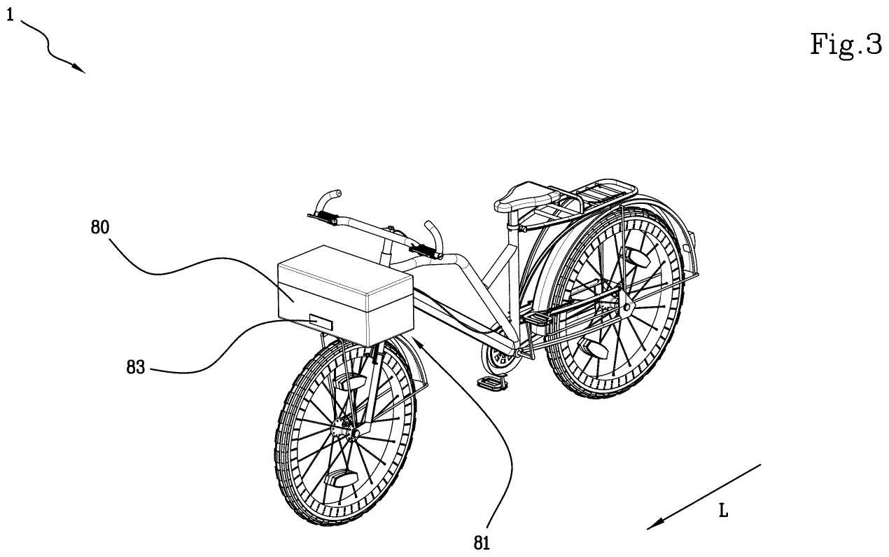

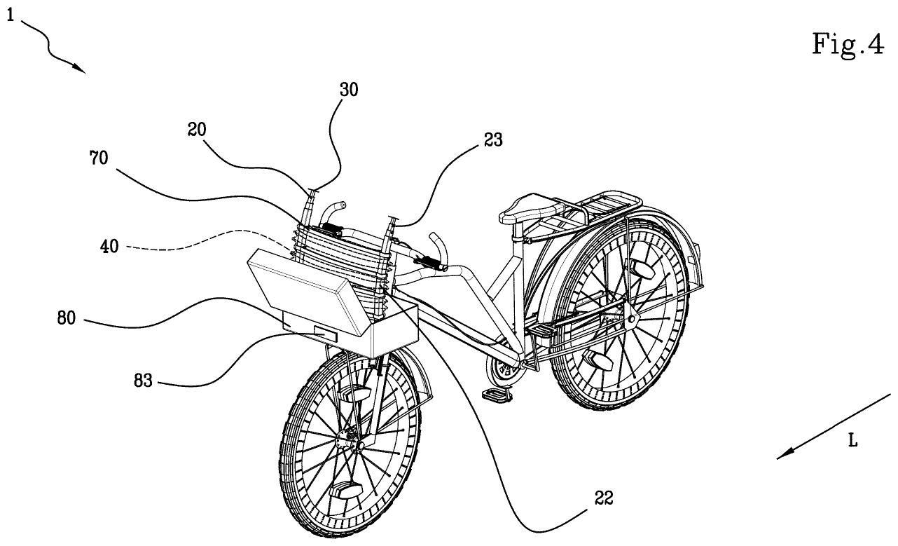

Mainly in FIGS. 3 and 4, the aforesaid apparatus 10 is illustrated, which comprises a container 80 removably connectable to a portion of the vehicle for containing the pair of uprights 20 in the rest configuration and the covering 40 in the compact condition.

In other words, the container 80 is advantageously removable from the vehicle when the apparatus 10 is not being used, i.e. when the covering 40 is in the compact condition and the uprights 20 are in the rest configuration.

More precisely, the container 80 is connectable to the portion of the vehicle with a quick coupling device 90 (FIG. 9) which allows the connection and removal thereof simply and quickly.

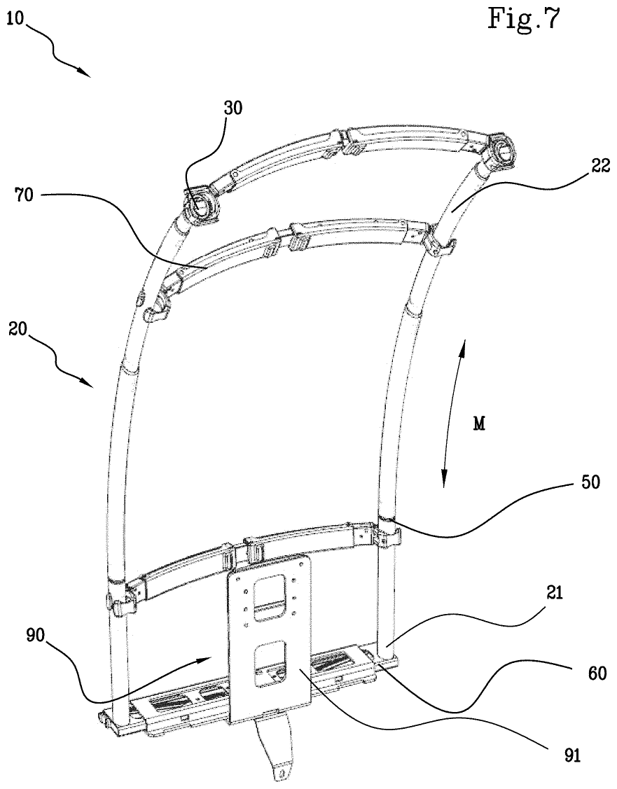

According to an aspect of the invention illustrated in FIG. 7, the quick coupling device 90 comprises a plate 91, which is connectable to the anchoring device 60 and/or to the container 80, and an external connector 92, which is connectable to the vehicle and to the plate 91.

Preferably, the plate 91 has a substantially L-shaped conformation to define a support bracket able to support the anchoring device 60 and/or the container 80 and, at the same time, define one or more coupling points with the external connector 92 and/or with the vehicle.

In other words, the plate 91 comprises a first portion connectable at the bottom to the anchoring device 60 (or to the base 81 of the container 80) and to a possible luggage carrier of the vehicle, and a second portion transversal to the first one connectable to the container 80, if present, and to the external connector 92.

Advantageously, the plate 91 allows the apparatus 10 to be anchored to a front luggage carrier of the vehicle and/or directly to the handlebar thereof. Even more advantageously, in the event that the apparatus 10 comprises the container 80, the plate 91 is inserted inside it so that the second portion extends at the rear wall 82 up to an opening formed on the same rear wall 82 through which the second portion of the plate 91 is able to be connected to the external connector 92.

Preferably, the plate 91 is made of metal to define a secure and solid support for the entire apparatus 10. Additionally, the container 80 is sized so as to contain the anchoring device 60 both when it is pre-set to the minimum width thereof, and when it is pre-set to the maximum width thereof, and also the uprights 20 in the rest configuration. Possibly, the container 80 has side openings such as to allow the maximum widening of the anchoring device 60.

In other words, the apparatus 10 described previously is contained within the container 80, completely in the case in which the pair of uprights 20 is moved into the rest configuration and the covering is in the compact condition, only partially when the pair of uprights 20 is in the operating configuration and the covering in the stretched condition.

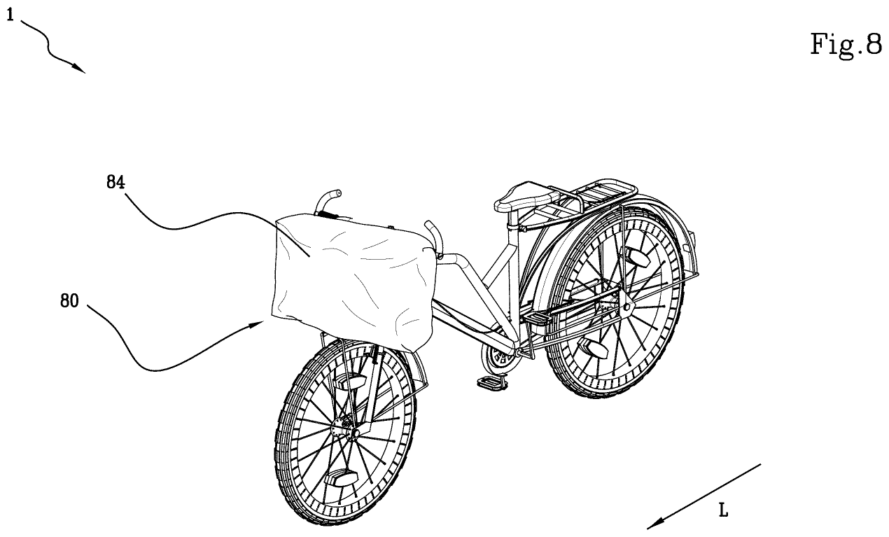

According to an aspect of the invention illustrated in FIG. 8, the container 80 is a waterproof bag. Advantageously, when the pair of uprights is in the operating configuration and the covering 40 is in the stretched condition, the container 80 is totally covered by the covering 40 arranged to the front thereof. In other words, as can be seen better in FIG. 9, the opening of the container 80 implies that a cover 84 is totally arranged in a containment volume V defined between the covering 40 in the stretched condition and a rear wall 82 of the container 80, which is connected to the vehicle through the quick coupling device 90. Therefore, both the container 80 and the cover 84 itself are protected by the extension of the pair of uprights 20 and the covering 40.

Advantageously, the containment volume V defined between the rear wall 82 of the container 80 and the covering 40 in the stretched condition can be used as a housing compartment protected from atmospheric agents also usable during the use of the same apparatus 10.

According to another aspect of the invention, the container 80 comprises a base 81 that can be anchored to the portion of the vehicle and to which the anchoring device 60 is connected. Each upright 20, through the articulation element 50, in the rest configuration is arranged parallel to the base 81, so that each abutment element 30 is substantially arranged in proximity to the end 21 of the other upright 20.

In this configuration, the cross members 70 are housed between each articulation element 50 and the anchoring device 60, substantially along the end portions of the anchoring device 60, which are transversal to the base 81 of the container 80.

In the event in which the covering 40 is arranged in the compact condition inside the container 80 following a storm, any deposit of water that could drip from the covering 40 into the container 80 would not stagnate, as the base 81 is provided with a relevant drainage hole able to discharge any water present.

To provide better visibility of the vehicle and for the vehicle, the container 80 has housings 83 in which luminous devices are connectable for illuminating along the advancement direction L of the vehicle and reflecting devices for increasing the visibility thereof.

Additionally, the container 80 comprises an external object-holder appendage (not illustrated). Preferably, the external appendage is arranged frontally to the container 80 and allows the user of the vehicle to position objects inside it when the pair of uprights 20 is arranged in the rest position inside the container 80.

According to an aspect of the invention, the covering 40 comprises a pair of slotted portions 43. Such slotted portions 43 allow the covering 40 to slide along the pair of uprights 20 between the anchoring device 60 and each abutment element 30.

To allow the sliding along the pair of uprights 20, two opposite sides of the covering 40 have slots or folded and sewn portions to form a sliding channel.

Preferably, the covering 40 is a cloth treated with a hydrorepellent product for making it waterproof.

Alternatively, the covering 40 is an oilskin or waterproof plastic cloth without the addition of specific products.

FIG. 5 shows the covering 40 made at least in part of a transparent material, mainly at at least part of the front protective shield 41, for allowing visibility along the advancement direction for the user. Alternatively, the covering 40 has a through opening 44 at the front protective shield 41 to facilitate the visibility of the user along the advancement direction L. Additionally, a cover 45, preferably transparent, can be positioned at the through opening 44 and fixed through the use of velcro or a zip to provide greater protection of the user.

Finally, along each slotted portion 43 of the covering 40 there is a tensioning element (not illustrated) for tensioning the covering 40 on the pair of uprights 20 in the operating configuration.

The tensioning element is a zip arranged along the covering 40 at each upright 20. The closing of the latter moves the two flaps of covering towards each other 40 for tensioning it. On the contrary, the opening allows the flaps to be moved away from each other and therefore easier sliding of the covering 40 along the pair of uprights 20.

According to a further aspect of the present invention, the covering 40 comprises solar panels useful for charging batteries.

The subject matter of the present patent application is also a bicycle 1 on which the apparatus 10 previously described is installed.

As can be seen in FIGS. 3, 4, 5, the apparatus 10 is connected to a front portion of the bicycle, with respect to an advancement direction L thereof, at the handlebar.

FIGS. 3, 4, 5 show that the container 80 is connected to the frame of the bicycle 1 at the front fork through its own base 81. Furthermore, the container 80 has the external appendage connected to a front wall thereof, on which a headlamp is positioned, able to illuminate along the advancement direction L. The pair of uprights 20 in the operating configuration extends along the curved movement direction M towards the rear portion of the bicycle 1 so as to protect the user with the front protective shield 41 and the upper protective shield 42.

According to an aspect of the invention, the covering 40 comprises a further portion of fabric (not illustrated) able to form a rear protective shield with respect to the advancement direction L of the vehicle and a further portion of fabric (not illustrated) able to cover the external appendage at the front.

In practice, when the covering 40 is in the stretched condition, the further portion of fabric stretches from the abutment elements 30 to a rear portion of the vehicle, in the specific case of a bicycle 1, to which it can be constrained.

Additionally, the covering 40 has a slot (not illustrated) for the passage of air and located between the front protective shield 41 and the upper protective shield 42 when the covering 40 is in the stretched condition. Specifically, such slot is obtained with the partial superposition of a portion of the upper shield 42 on a portion of the front shield 41.

The subject matter of the present patent application is also a method for the implementation of an apparatus 10 for covering a vehicle emplacement, in particular a bicycle 1.

The implementation method comprises the operating steps of:
providing a pair of extendible uprights 20, each of which has an end 21 connected to a portion of the vehicle. The uprights 20 are movable between a rest configuration, in which they extend by a minimum length, and an operating configuration, in which they have a predetermined length such as to cover at least part of the vehicle emplacement;
providing at least one abutment element 30 solidly associated with a portion of a respective upright 20;
slidably arranging a covering 40 along the pair of uprights 20 between each end 21 and the respective abutment element 30. Specifically, the covering 40 is configurable between a compact condition, in which it is entirely wrapped between the pair of uprights 20 in a rest configuration, and a stretched condition in which it is stretched along the pair of uprights 20 in an operating configuration so as to cover at least part of the vehicle emplacement;
slidably removing the covering 40 in a movement direction M that extends between the end 21 and the abutment element 30 of each upright 20 from the compact condition to the stretched condition. In particular, the covering 40 is configured to come into contact with each abutment element 30 for pulling it in the movement direction M and extending each upright 20 from the rest configuration to the operating configuration. Additionally, the method comprises the further steps of:
arranging a cross member 70 slidably movable along the movement direction M between each end 21 and each abutment element 30 of the pair of uprights 20;
connecting the cross member 70 to the covering 40;
moving the cross member 70 along the movement direction M for engaging it with each abutment element 30 so as to move the pair of uprights 20 between the rest configuration and the operating configuration. The interposition of a slidable cross member 70 along the pair of uprights 20 allows greater rigidity to be conferred to the entire apparatus 10 when the pair of uprights 20 is in the operating configuration. Furthermore, the cross member 70 offers the user a more convenient and practical pulling portion for moving the covering 40 into the stretched condition and simultaneously the pair of uprights 20 into the operating configuration. Possibly, the method also comprises the steps of:
interposing an anchoring device 60 between each upright 20 and a portion of the vehicle;
varying the width of the anchoring device 60 for varying the distance that exists between the pair of uprights 20 in the operating configuration.

In this way, according to requirements, it is advantageously possible to vary the width of the protective screen offered by the covering 40 stretched onto the pair of uprights 20 in the operating configuration between a minimum width of about 40 centimetres and a maximum width of about 60 centimetres.

Advantageously, the adjustment of the width of the anchoring device 60 allows the covering 40 to be brought into tension after it has been removed from the compact condition to the stretched condition.

Therefore, even more advantageously, when the anchoring device 60 is configured with a smaller width than the maximum one, the covering 40 is not in tension and it is simpler and quicker to move it between the compact condition and the stretched one and vice versa.

Finally, the method comprises the step of providing a container 80 removably connected to a portion of the vehicle for containing the pair of uprights 20 in the rest configuration and the covering 40 in the compact condition.

The container 80, advantageously, allows a collection point to be provided for the pair of uprights 20 and the covering 40 when in the rest condition and in the compact condition, respectively.

With regard to an operating example of the apparatus 10 for covering a vehicle emplacement, it derives directly from what is described above which is referred to below.

A container 80 is arranged on a bicycle 1 at a front portion of the frame. Inside the container 80 the pair of uprights 20 and the covering 40 are arranged. Each upright 20 is connected to the base 81 of the container 80 through an articulation element 60 and an anchoring device 50, which is connected directly to the base 81 and is substantially U-shaped.

The covering 40 is made to slide along the pair of uprights 20 and arranged in a compact configuration, in which it is folded to be comprised between the anchoring device 60 and the articulation elements 50.

A cross member 70 is connected to the covering 40 and is inserted slidably along the pair of uprights 20; it is also arranged below the articulation elements 50 between the two opposite and transversal portions to the base 81 of the anchoring device 60.

The pair of uprights 20 is then moved into the rest configuration, in which each of them is arranged parallel to the base 81, substantially to cover the covering 40 in the compact condition and the cross member 70.

A user, also at the vehicle emplacement, can grasp the cross member 70 and remove it from the container 80. The removal allows each upright 20 to be rotated around the articulation element 50 and induces the cross member to slide along the uprights 20 until it abuts each abutment element 30.

The collision between the cross member 70 and the abutment elements 30 allows the extension of the telescopic uprights 20 by a predefined length and, at the same time, allows the movement of the covering 40 from the compact condition to the stretched condition.

Additionally, it is possible to stretch the covering 40 closing the zip placed at each slotted portion 43 along each upright 20.

According to an aspect of the invention, it is possible to automate the movement mechanism of the pair of uprights 20 and the sliding mechanism of the covering 40 and of any cross members 70.

1. An apparatus for covering a vehicle emplacement of a user, in particular a bicycle, comprising:
a pair of extendible uprights, each of which has an end removably connectable to a portion of the vehicle, each upright being movable between a rest configuration, in which it is extended by a minimum length, and an operating configuration, in which it extends by a predetermined length such as to cover at least part of the vehicle emplacement;
at least one support solidly associated with a portion of each upright;
a covering to protect a user located at the vehicle emplacement that is configurable between a compact condition, in which it is entirely wrapped between said pair of uprights in a rest configuration, and a stretched condition in which it is stretched along said pair of uprights in an operating configuration so as to cover at least part of said vehicle emplacement, said covering being slidably movable along a movement direction (M) that extends between said end and said support of each upright, said covering being configured to come into contact with each support for pulling it in the movement direction (M) and extending each upright from the rest configuration to the operating configuration while the covering stretches from the compact condition to the stretched condition;
an anchor interposed between each upright and the portion of the vehicle; said anchor having a variable width for varying the distance that exists between said pair of uprights,
wherein said pair of uprights in the operating configuration extend along a curved movement direction (M) so as to form, with said covering in the stretched condition, a front protective shield with respect to an advancement direction (L) of the vehicle and an upper protective shield with respect to a vehicle emplacement.

2. The apparatus according to claim 1, wherein each upright can be moved by folding between the rest configuration and the operating configuration so that the uprights in the rest configuration are substantially stacked against each other and in the operating configuration are substantially extended parallel to each other to cover at least part of the vehicle emplacement.

3. The apparatus according to claim 1, comprising at least one articulation element interposed between said end of each upright and the portion of the vehicle for moving by folding said pair of uprights between the rest configuration and the operating configuration.

4. The apparatus according to claim 1, wherein each upright is telescopic; each upright comprising a plurality of rods slidably inserted inside each other for extending the respective upright between said minimum length and said predetermined length.

5. The apparatus according to claim 4, wherein each upright comprises at least one lock interposed between two rods to lock the mutual position thereof and define the predefined length of each upright in the operating configuration.

6-7. (canceled)

8. The apparatus according to claim 1, comprising at least one cross member slidably movable along said movement direction (M) between the anchor and each support of said pair of uprights; said cross member being shaped to engage with each support for moving said pair of uprights between the rest configuration and the operating configuration; said cross member being operatively connected to said covering.

9. The apparatus according to claim 8, wherein said cross member is telescopic for having a variable width as a function of the width of said anchor.

10. The apparatus according to claim 8, comprising a plurality of said cross members slidably movable along said movement direction (M) between said anchor and each support of said pair of uprights.

11. The apparatus according to claim 1, comprising a container removably connectable to a portion of the vehicle for containing said pair of uprights in the rest configuration and said covering in the compact condition.

12. (canceled)

13. The apparatus according to claim 11, wherein said container has a containment volume (V) and comprises a lid being movable between a closing configuration, in which it defines a cover for said anchor, said pair of uprights in the retracted configuration, said covering in the compact condition and said containment volume (V), and an opening configuration, in which said covering in the stretched condition extends to cover said lid which defines a cover for said containment volume (V).

14. The apparatus according to claim 11, wherein said container is made with flexible and/or waterproof material.

15-19. (canceled)

20. The apparatus according to, wherein at least one part of said front protective shield is transparent.

21-23. (canceled)

24. A method for implementing the apparatus for covering a vehicle emplacement for a user, in particular a bicycle, comprising:
providing a pair of extendible uprights, each of which has an end connected to a portion of the vehicle, said uprights being movable between a rest configuration, in which they extend by a minimum length, and an operating configuration, in which they have a predetermined length such as to cover at least part of said vehicle emplacement;
providing at least one support solidly associated with a portion of a respective upright;
slidably arranging a covering to protect a user located at the vehicle emplacement along said pair of uprights between each end and the respective support, said covering being configurable between a compact condition, in which it is entirely wrapped between said pair of uprights in a rest configuration, and a stretched condition, in which it is stretched along said pair of uprights in an operating configuration so as to cover at least part of the vehicle emplacement;
slidably removing said covering in a curved movement direction (M) that extends between said end and said support of each upright from the compact condition to the stretched condition so as to form a front protective shield with respect to an advancement direction (L) of the vehicle and an upper protective shield with respect to a vehicle emplacement, said covering being configured to come into contact with each support for pulling it in the movement direction (M) and simultaneously extending each upright from the rest configuration to the operating configuration and stretching the covering from the compact condition to the stretched condition;
interposing an anchor between each upright and a portion of the vehicle;
varying the width of said anchor for varying the distance that exists between said pair of uprights in the operating configuration.

25. The method according to claim 24, further comprising:
arranging a cross member slidably movable along said movement direction (M) between each end and each support of said pair of uprights;
connecting said cross member to said covering;
moving said cross member along said movement direction (M) to engage with each support so as to move said pair of uprights between the rest configuration and the operating configuration.

26. The method according to claim 24, further comprising providing a container removably connectable to a portion of the vehicle to contain said pair of uprights in the rest configuration and said covering in the compact condition.
